(19) United States
(12) Patent Application Publication
(10) Pub. No.: US 2005/0169004 A1
(43) Pub. Date: Aug. 4, 2005

(54) Luminous warning device for making presence of a vehicle conspicuous

(76) Inventors: Tzu-Wen Liu, Chan Hua City (TW); Pei-Chin Yao, Taichung City (TW)

Correspondence Address: LAW OFFICE OF LIAUH & ASSOC., 4224 WAIALAE AVE, STE 5-388, HONOLULU, HI, 96816, US

(21) Appl. No.: 09/871,398

(22) Filed: May 30, 2001

(51) Int. Cl. B60Q 1/00

(52) U.S. Cl. 362/500

(57) ABSTRACT

A luminous warning device comprises two fastening mounts and a coil box. The fastening mounts are fastened to a fork tube of a vehicle and are provided with a magnet to effect a magnetic field. The coil box contains a plurality of coils and light-emitting diode bulbs. The coil box is fastened to the wheel of the vehicle. As the wheel is turned, the coil box passes through the magnetic field to bring about an electric potential which enables the light-emitting diode bulbs to emit light.

### FIELD OF THE INVENTION

The present invention relates generally to a warning device, and more particularly to a light-emitting device for making the presence of a vehicle conspicuous to operators of other vehicles, so as to prevent the traffic accident.

### BACKGROUND OF THE INVENTION

A vehicle, such as bicycle, is prone to an accident while it is operated in a dark or poorly-lit place where the visibility is so poor that the operator of a motor vehicle may not be aware of the presence of the bicycle. Under such a circumstance, the bicycle is vulnerable to an accident in which the bicyclist is likely to get hurt. For this reason, it is imperative that the bicycle, or the like, must be provided with a warning device to make the operators of motor vehicles to remain watchful and alert to the presence of the bicycle. In other words, the warning device is intended to safeguard the rider of a bicycle operating in a dark or poorly-lit place.

The bicycle is often provided with one or more reflectors which are fastened to the bicycle wheels to bring about a warning effect. However, the reflectors may be useless in the event that the operator of a motor vehicle forgets to turn on the headlights of the motor vehicle.

As shown in FIGS. 1 and 2, the Taiwan Patent Serial Number 83208366 discloses a bicycle light-emitting device capable of flashing. The device comprises an upper housing 10, a lower housing 20, and a PC board 30 which is located between the upper housing 10 and the lower housing 20 and is provided with a battery, a spring 31, a swing ball 32 connected with the spring 31 serving as a control switch of the device, and two conductive rods 33. The device is fastened to the spokes of the bicycle wheel, as illustrated in FIG. 2. The device is caused to emit light at the time when the centrifugal force of the bicycle wheel in motion triggers the spring 31 to cause the swing ball 32 to come in contact with the conductive rod 33. This prior art device is defective in design in that the battery is apt to become exhausted, and that the upper housing 10 and the lower housing 20 must be separated to facilitate the replacing of the battery.

### SUMMARY OF THE INVENTION

It is the primary objective of the present invention to provide a luminous warning device free of the shortcomings of the prior art devices described above. The device of the present invention comprises two fastening mounts which are fastened to two fork blades of a bicycle frame and are provided with a magnet. The device of the present invention further comprises a coil box having a plurality of coils and a plurality of LED(light-emitting diode) bulbs. The coil box is fastened to the spokes of the bicycle wheel. As the bicycle wheel is turned, the coil box is turned along to pass the magnetic field brought about by the two magnets which are fastened to the two fastening mounts. As a result, the magnetic field effect is cut by the coil box passing therethrough, thereby resulting in an electric potential which enables the LED bulbs to emit light to caution the operators of motor vehicles about the presence of the bicycle.

It is another objective of the present invention to provide a luminous warning device with a coil box which comprises a plurality of coils and LED bulbs connected with the coils. The coils are arranged in parallel connection to enable the LED bulbs to emit light one after another at the time when each coil cuts through the magnetic filed.

It is still another objective of the present invention to provide a luminous warning device with a coil box which comprises a plurality of coils in parallel connection. LED bulbs, and capacitors connected with the coils for storing an electric charge. The light-emitting duration of the LED bulbs is prolonged by the discharge of the capacitors.

It is still another objective of the present invention to provide a luminous warning device capable of bringing about an electric potential which is directly proportional in magnitude to the rotational speed of the bicycle wheel, thereby resulting in an increase in intensity of light emitted by the LED bulbs, as well as prolonging the light-emitting duration of the LED bulbs. As a result, the speed of the bicycle in motion may be judged by intensity and duration of light emitted by the LED bulbs.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows an exploded view of a bicycle light-emitting device of the prior art.

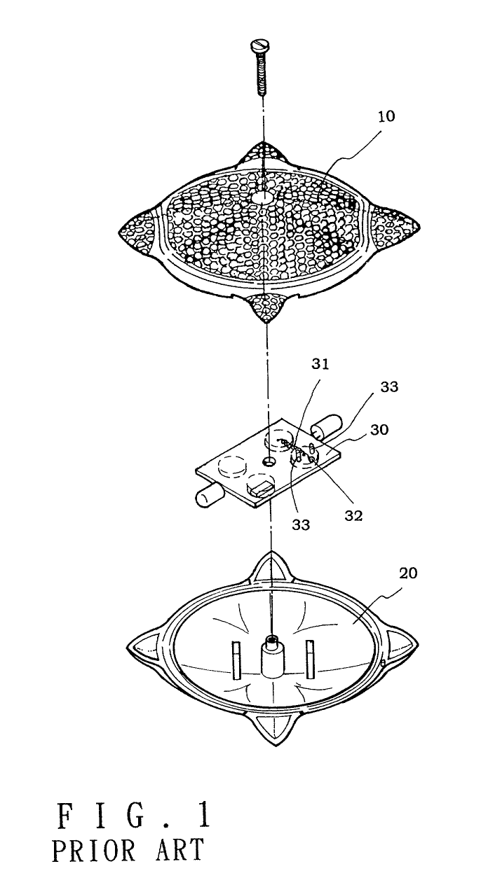

FIG. 2 shows a schematic view of the prior art bicycle light-emitting device in use.

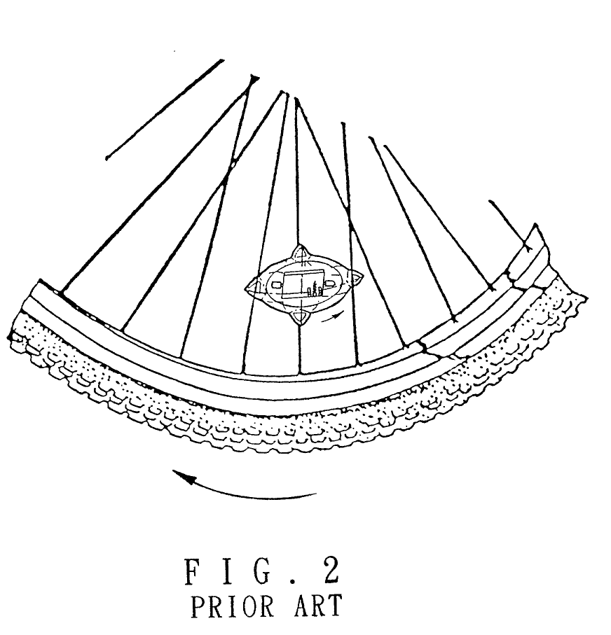

FIG. 3 shows an exploded view of the preferred embodiment of the present invention.

FIG. 4 shows a schematic view of the preferred embodiment of the present invention in use.

FIG. 5 shows a schematic view of the preferred embodiment of the present invention passing through the magnetic field.

FIG. 6 shows a schematic view of the preferred embodiment of the present invention at work.

### DETAILED DESCRIPTION OF THE PREFERRED EMBODIMENT

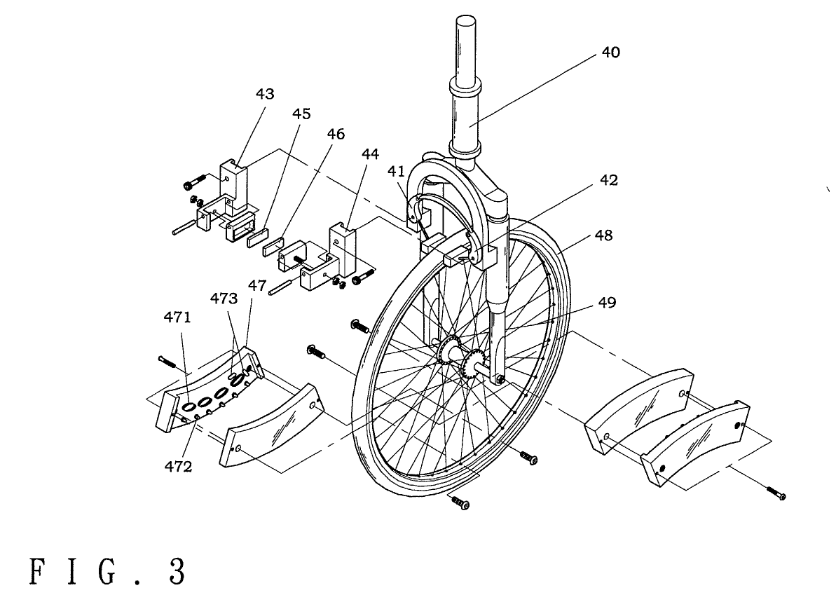

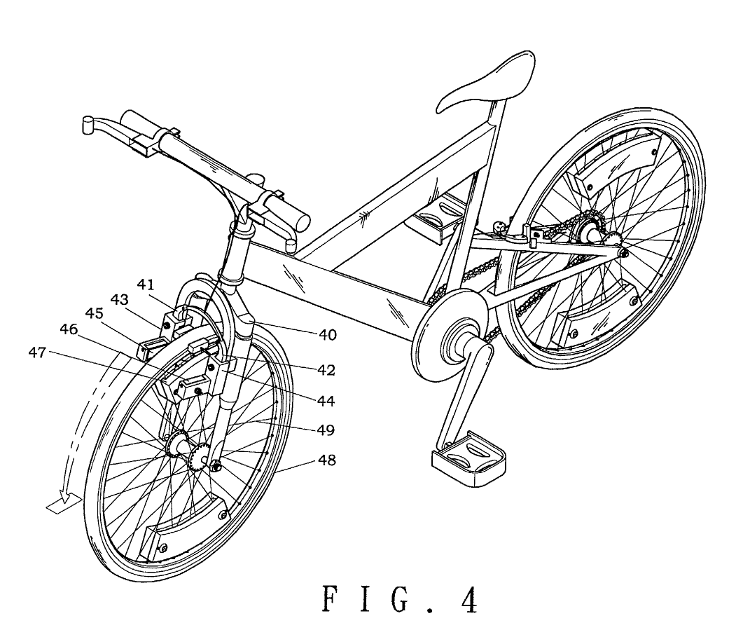

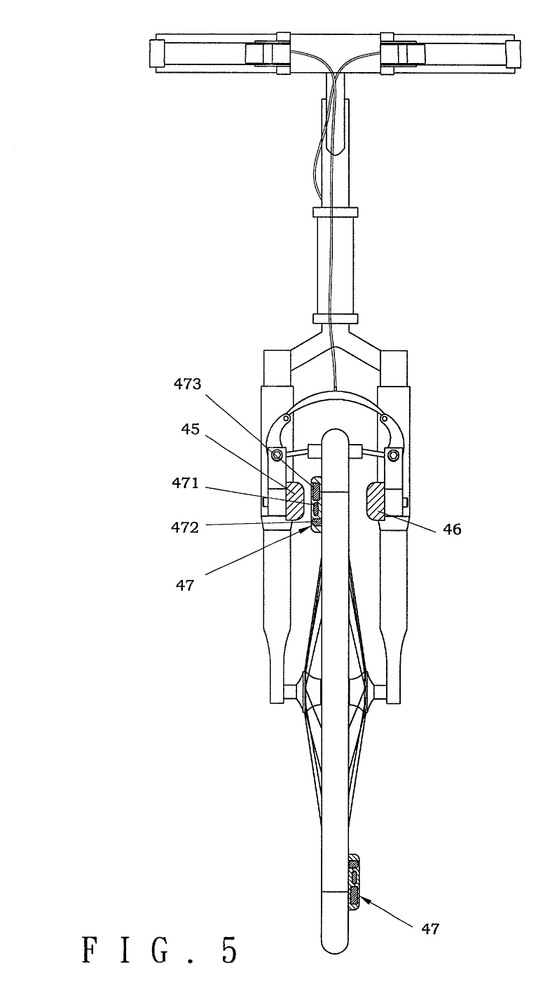

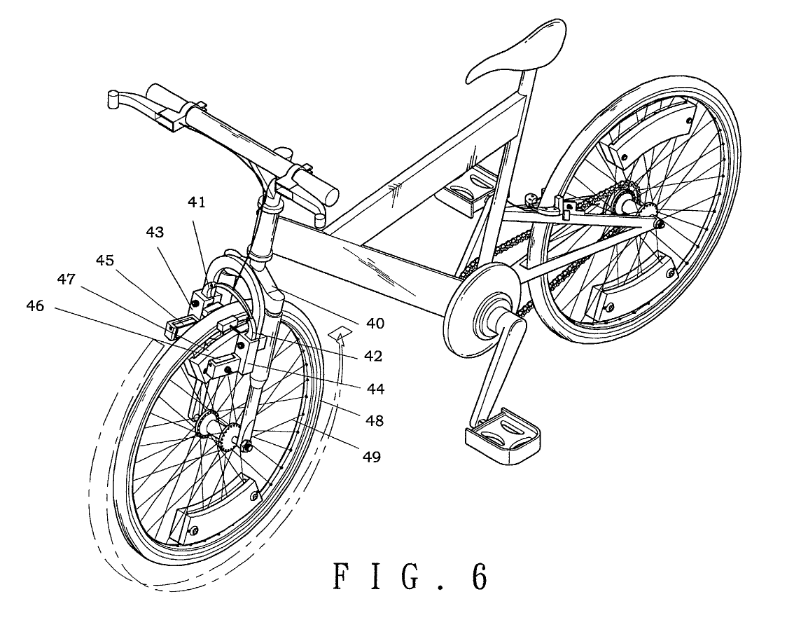

As shown in FIGS. 3 and 4, a luminous warning device of the preferred embodiment of the present invention comprises two fastening mounts 43 and 44, which are fastened respectively to two front brakes 41 and 42 of a bicycle front fork 40. The first fastening mount 43 is provided with a first magnet 45, whereas the second fastening mount 44 is provided with a second magnet 46 opposite in magnetic pole to the first magnet 45. The luminous warning device of the present invention further comprises a coil box 47, which is formed of a plurality of coils 471 in parallel connection, a plurality of light-emitting diode(LED) bulbs 472 connected to the coils 471 respectively, and a plurality of capacitors 473 connected to the coils 471 respectively for fast storage of electric charge. The coil box 47 is fastened with spokes 49 of a bicycle front wheel 48, as shown in FIGS. 3 and 4. The coils 471 of the coil box 47 are arranged in such a manner that they are corresponding in location to a through magnetic field formed by the first magnet 45 and the second magnet 46, and that the arrangement of the coils 471 is perpendicular to the magnets 45 and 46. As the coil box 47 is turned along with the bicycle wheel 48 in motion, the coils 471 pass through a magnetic field brought about by the two magnets 45 and 46, thereby resulting in a magnetic field cutting effect. As illustrated in FIG. 5, when the coils 471 are exerted on by an external force by the bicyclist such that the coils 471 cut through the magnetic field, the work done by the external force is equal to the energy that is needed for an induction electric potential ε to drive the electric charge to flow on the coils 471. In light of the work and the energy being equal in magnitude to each other within a unit time Δt, εIΔt=−ILB·VΔt, therefore, ε=LVB, in which L stands for an effective length of the coils; V, moving speed; B, magnetic flux density. Under the circumstance that number of turns of the coils in n, ε=nLVB. It is therefore readily apparent the magnitude of the induction electric potential is related to the magnetic flux density B, the effective length L passing through the magnetic field, the number of turns of the coils n, and the speed V, at the time when the coils 471 pass through the magnetic field. Because of the limitation in size of the ordinary bicycle wheels, there is an ultimate effective length L, as well as an ultimate bicycle speed. As a result, the design must be based on the oversize nB value, so as to attain a better electric potential. Now referring to FIGS. 3 and 6, when the coil box 47 of the present invention cuts through the magnetic field, an electric potential in brought about to cause the LED bulbs 472 to emit light. In light of the LED bulbs 472 being on the coils 471 in parallel connection, as well as the continuous magnetic field cutting effect, the LED bulbs 472 emit light in a continuous manner. Such a continuous emission of light by the LED bulbs 472 is further enhanced by the discharge action of the capacitors 473. According to the equation of ε=nLVB, the electric potential is directly proportional to the speed of the bicycle in motion. This means that the intensity of light emitted by the LED bulbs 472 becomes greater as the bicycle cruises at a greater speed. In the meantime, more electric energy is stored in the capacitors 473 to enable the LED bulbs 472 to emit light for a prolonged period of time. It is therefore possible to judge the cruising speed of the bicycle on the basis of the intensity of light emitted by the LED bulbs 472 and the light-emitting duration of the LED bulbs 472. The operators of motor vehicles may be therefore guided to maneuver properly to prevent an accident.

The embodiment of the present invention described above is to be regarded in all respects as being merely illustrative and not restrictive. Accordingly, the present invention may be embodied in other specific forms without deviating from the spirit thereof. The present invention is therefore to be limited only by the scopes of the following claims.

1. A luminous warning device comprising:
a first fastening mount fastened to one side of a fork tube of a vehicle and provided with a first magnet fastened thereto;
a second fastening mount fastened to other side of the fork tube of the vehicle such that said second fastening mount is opposite in location to said first fastening mount, said second fastening mount being provided with a second magnet fastened thereto, said second magnet being opposite in magnet poles to said first magnet; and
a coil box fastened to a wheel of the vehicle and formed of a plurality of coils and LED (light-emitting diode) bulbs whereby said coils bring about an electric potential at the time when said coil box is turned along with the wheel in motion to cut through a magnetic field effected by said first magnet and said second magnet, said electric potential enabling said LED bulbs to emit light.

2. The luminous warning device as defined in claim 1, wherein said coils of said coil box are arranged in parallel connection; wherein said LED bulbs are respectively connected to said coils.

3. The luminous warning device as defined in claim 1, wherein said coil box is further formed of a plurality of capacitors whereby said capacitors are connected to said coils.
